(19) United States
(12) Patent Application Publication
(10) Pub. No.: US 2024/0273751 A1
(43) Pub. Date: Aug. 15, 2024

(54) OBJECT DETECTION APPARATUS AND OBJECT DETECTION METHOD

(71) Applicant: Mitsubishi Electric Corporation, Tokyo (JP)

(72) Inventor: Tatsuya KAMIMURA, Tokyo (JP)

(73) Assignee: Mitsubishi Electric Corporation, Tokyo (JP)

(21) Appl. No.: 18/563,942

(22) PCT Filed: Jun. 2, 2021
(86) PCT No.: PCT/JP2021/021004

§ 371 Date: Nov. 24, 2023

(51) Int. Cl. G06T 7/70; G01S 13/06; G01S 13/66; G01S 13/86; G06T 7/20

(52) U.S. Cl. CPC G06T 7/70; G01S 13/06; G01S 13/66; G01S 13/867; G06T 7/20

(57) ABSTRACT

An object detection apparatus includes a signal processor that computes radar position data and radar velocity data on the basis of a reflected signal received by a radar; an image processor that computes camera velocity data indicating a velocity of the object on the basis of image information obtained by a camera; and a fusion processor that outputs, to a vehicle control device, the radar position data and the radar velocity data of a first frame as first detected position data and first detected velocity data. When the radar position data and the radar velocity data of a second frame following the first frame are lost, the fusion processor generates, on the basis of the first detected position data and the camera velocity data of the second frame, and outputs, to the external device, second detected position data and second detected velocity data for the second frame.

### FIELD

The present disclosure relates to an object detection apparatus and an object detection method for detecting objects.

### BACKGROUND

An onboard object detection apparatus quickly detects objects such as people and obstacles present in an environment where a vehicle is used. Data on an object detected by this object detection apparatus is used for vehicle control, alert notification, and others, thus enabling safe vehicle operation.

Object detection apparatuses use sensors such as a radar, a camera, a light detection and ranging (LIDAR) sensor, and an ultrasonic sensor. In recent years, with the spread of various sensors, object detection apparatuses of a fusion type that use combinations of plural types of sensors for providing improved performance have been widely used.

An object detection device described in Patent Literature 1 is a fusion-type object detection device using a radar and a camera. This object detection device described in Patent Literature 1 outputs object detection data on the basis of object position data detected using the radar and object position data detected using the camera.

### CITATION LIST

### Patent Literature

Patent Literature 1: PCT International Publication No. 2010/119860

### SUMMARY OF INVENTION

### Problem to be Solved by the Invention

However, a problem with the above technique described in Patent Literature 1 is higher manufacturing costs of the object detection device because the camera to be used in detecting the object position data is of high performance for accurate object detection.

The present disclosure has been made in view of the above, and an object of the present disclosure is to obtain an object detection apparatus capable of accurately detecting an object at a lower manufacturing cost.

### Means to Solve the Problem

To solve the above problem and achieve the object, an object detection apparatus of the present disclosure comprises: a radar to emit an electromagnetic wave toward an object and receive a reflected signal from the object; a signal processor to compute radar position data and radar velocity data on a basis of the reflected signal, the radar position data indicating a position of the object, the radar velocity data indicating a velocity of the object; a camera to obtain object image information by capturing an image of the object; and an image processor to compute camera velocity data on a basis of the object image information, the camera velocity data indicating a velocity of the object. The object detection apparatus of the present disclosure comprises a fusion processor to output, to an external device, the radar position data and the radar velocity data of a first frame as first detected position data and first detected velocity data, the first detected position data indicating the position of the object for the first frame, the first detected velocity data indicating the velocity of the object for the first frame. The fusion processor includes a data store to store the first detected position data. When the radar position data and the radar velocity data of a second frame following the first frame are lost, the fusion processor generates second detected position data indicating the positon of the object for the second frame and second detected velocity data indicating the velocity of the object for the second frame on a basis of the first detected position data and the camera velocity data obtained for the second frame, and outputs the generated second detected position data and the generated second detected velocity data to the external device.

### Effects of the Invention

The object detection apparatus according to the present disclosure has an advantageous effect of accurately detecting the object at the lower manufacturing cost.

### BRIEF DESCRIPTION OF DRAWINGS

FIG. 1 is a diagram illustrating a configuration of an object detection apparatus according to a first embodiment.

FIG. 2 is a flowchart illustrating an object detection procedure to be performed by the object detection apparatus according to the first embodiment.

FIG. 3 is a diagram illustrating a configuration of an object detection apparatus according to a second embodiment.

FIG. 4 is a flowchart illustrating an object detection procedure to be performed by the object detection apparatus according to the second embodiment.

FIG. 5 is a diagram illustrating a configuration example of processing circuitry of each of the object detection apparatuses according to the first and second embodiments when the processing circuitry is realized by a processor and a memory.

FIG. 6 is a diagram illustrating an example of processing circuitry of each of the object detection apparatuses according to the first and second embodiments when the processing circuitry is configured as dedicated hardware.

### DESCRIPTION OF EMBODIMENTS

With reference to the drawings, a detailed description is hereinafter provided of object detection apparatuses and object detection methods according to embodiments of the present disclosure.

### First Embodiment

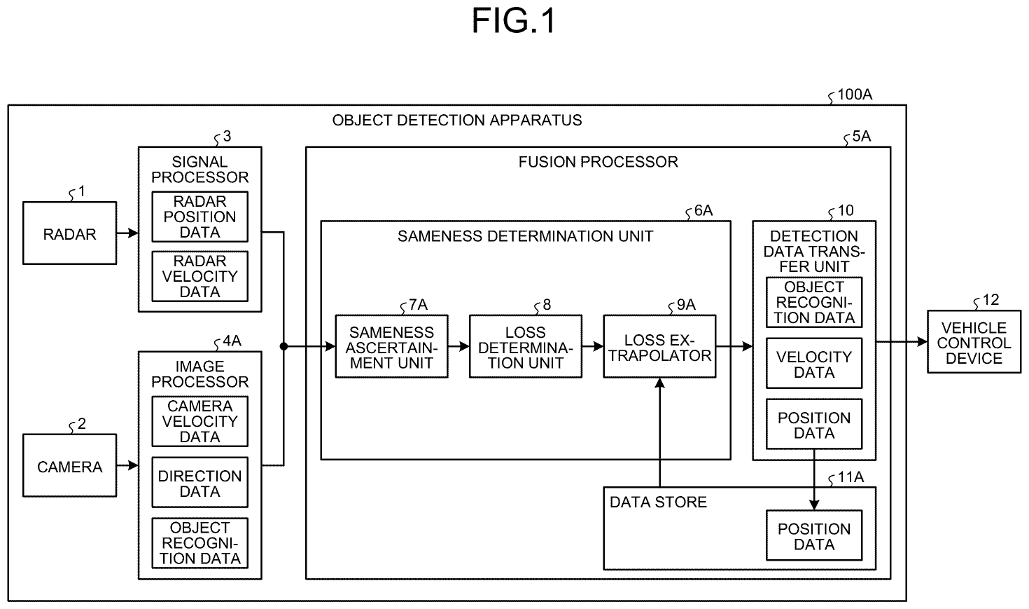

FIG. 1 is a diagram illustrating a configuration of an object detection apparatus according to a first embodiment. The object detection apparatus 100A is a fusion-type object detection apparatus including a combination of plural types of sensors and computes object detection data on the basis of data obtained from the plural types of sensors. When the object detection data is lost due to an operating environment, the object detection apparatus 100A uses detection data obtained for the preceding frame in inferring, among others, a position and a velocity, of an object. The detection data output from the object detection apparatus 100A is used in vehicle control and others.

The object detection apparatus 100A includes a radar 1, a camera 2, a signal processor 3, an image processor 4A, and a fusion processor 5A. The fusion processor 5A includes a sameness determination unit 6A, a detection data transfer unit 10, and a data store 11A. The sameness determination unit 6A includes a sameness ascertainment unit 7A, a loss determination unit 8, and a loss extrapolator 9A.

The radar 1 emits electromagnetic waves toward an object such as a person or an obstacle present in the environment where the object detection apparatus 100A is disposed, and receives a reflected signal from the object. When used in a vehicle, the radar 1 typically uses a frequency-modulated continuous wave (FMCW) method or a fast chirp modulation method (FCM). For example, the radar 1 includes a high-frequency semiconductor component, a power semiconductor component, a board, a quartz crystal device, a chip component, and an antenna, among others.

The signal processor 3 performs signal processing on the reflected signal (signal received) from the radar 1 to detect a position and a relative velocity, of the object. The signal processor 3 sends radar position data to the fusion processor 5A. The radar position data is the position data indicating the object's position computed on the basis of the signal received from the radar 1. The signal processor 3 sends radar velocity data to the fusion processor 5A. The radar velocity data is the velocity data indicating the object's velocity computed on the basis of the signal received from the radar 1. For example, the signal processor 3 is made up of a micro control unit (MCU), a central processing unit (CPU), or the like.

The camera 2 captures an image of the object, thus obtaining object image information. The camera 2 includes a lens, a holder, a complementary metal-oxide semiconductor (CMOS) sensor, a power semiconductor component, and a quartz crystal device, among others. The camera 2 needs only to be a low-performance camera that does not detect the object's position.

On the basis of the image information obtained by the camera 2, the image processor 4A performs object recognition and also computes a velocity of the object relative to the object detection apparatus 100A and a direction in which the object is located. For example, the image processor 4A is made up of an MCU, a CPU, or the like. The image processor 4A recognizes the object such as the person or the obstacle, using feature data obtained through machine learning or deep learning as a database and also detects the object's relative velocity and the direction. The feature data refers to data indicating characteristics of objects such as persons or obstacles.

The image processor 4A sends, to the fusion processor 5A, object recognition data indicating the recognition of the object. The object recognition data refers to data that tells whether the object is the person or the obstacle. When distinguishing between the person and the obstacle with one bit, the image processor 4A generates object recognition data “0” for the person and “1” for the obstacle, for example. The image processor 4A sends camera velocity data to the fusion processor 5A. The camera velocity data is the velocity data indicating the velocity of the object relative to the object detection apparatus 100A. The image processor 4A sends direction data to the fusion processor 5A. The direction data indicates the direction in which the object is located. The image processor 4A needs only to be a low-performance processor that does not compute the object's position.

The signal processor 3 of the object detection apparatus 100A computes and sends to the fusion processor 5A the radar position data and the radar velocity data on a frame-by-frame basis. The image processor 4A of the object detection apparatus 100A computes and sends to the fusion processor 5A the object recognition data, the camera velocity data, and the direction data on a frame-by-frame basis.

The signal processor 3 computes the radar position data and the radar velocity data at each specific timing. The image processor 4A computes the object recognition data, the camera velocity data, and the direction data at each specific timing. In cases where the signal processor 3 and the image processor 4A require the same signal processing time, the signal processor 3 and the image processor 4A perform their data computations at the same timing. In other words, the signal processor 3 and the image processor 4A compute their associated pieces of data on the object at the same time.

The timing at which both the signal processor 3 and the image processor 4A compute data corresponds to the frame. For example, if the signal processor 3 performs the data computation at the nth timing (where n is a natural number), the nth frame is to include the nth radar position data and the nth radar velocity data. If the image processor 4A performs the data computation at the nth timing, the nth frame is to include the nth object recognition data, the nth camera velocity data, and the nth direction data. The (n−1)th frame is defined as a first frame, and the nth frame is defined as a second frame.

The fusion processor 5A performs signal processing on the radar position data and the radar velocity data sent from the signal processor 3 and on the object recognition data, the camera velocity data, and the direction data sent from the image processor 4A. The fusion processor 5A outputs results of the signal processing that are detection results of the object detection apparatus 100A. The detection results of the object detection apparatus 100A include object recognition data, velocity data, and position data.

The sameness ascertainment unit 7A of the sameness determination unit 6A of the fusion processor 5A performs object sameness determination on the basis of the radar position data, the radar velocity data, the camera velocity data, the direction data, and the object recognition data. The object sameness determination is determination of whether the object detected by the radar 1 and the object detected by the camera 2 are the same.

Upon judging that the objects are the same as a result of performing the object sameness determination, the sameness ascertainment unit 7A associates the radar position data and the radar velocity data that have been obtained using the radar 1, with the object recognition data and the camera velocity data that have been obtained using the camera 2. The sameness ascertainment unit 7A sends, to the loss determination unit 8 connected downstream, data (hereinafter referred to as first correspondence data) associating the radar position data, the radar velocity data, the object recognition data, and the camera velocity data with each other.

The loss determination unit 8 determines whether there is loss of a signal for the radar position data and the radar velocity data that have been obtained using the radar 1. Signal loss state refers to a temporary state in which the object detection apparatus 100A cannot obtain the radar position data and the radar velocity data for the current detection frame, whereas the object detection apparatus 100A successfully obtained the radar position data and the radar velocity data for the preceding detection frame. In other words, the signal loss state refers to a situation in which the object detection using the radar 1 is unsuccessful while the object detection using the camera 2 is successful.

If there is no signal loss, the loss determination unit 8 sends the radar position data, the radar velocity data, and the object recognition data to the loss extrapolator 9A. If there is the signal loss, the loss determination unit 8 sends the object recognition data and the camera velocity data to the loss extrapolator 9A.

When detecting an object, using the radar 1, the object detection apparatus 100A cannot frequently detect the object as the desired object is hidden in clutter or multipath.

The loss extrapolator 9A performs data extrapolation only when the loss determination unit 8 has detected data loss. In the absence of signal loss, the loss extrapolator 9A sends, to the detection data transfer unit 10, the radar position data, the radar velocity data, and the object recognition data that have been sent from the loss determination unit 8. The radar position data, the radar velocity data, and the object recognition data are defined as the position data (the detected position data), the velocity data (the detected velocity data), and the object recognition data, respectively, all of which are detected by the object detection apparatus 100A.

In the presence of signal loss, the loss extrapolator 9A extrapolates position data and velocity data that are to be generated for the current frame into the current frame and transfers the position and velocity data to the detection data transfer unit 10. Specifically, in the presence of signal loss, the loss extrapolator 9A extrapolates the position data and the velocity data for the current frame on the basis of position data stored in the data store 11A and the camera velocity data, and sends the extrapolated position and velocity data to the detection data transfer unit 10. In other words, the loss extrapolator 9A transfers the generated position data, the generated velocity data, and the object recognition data to the detection data transfer unit 10 in the presence of signal loss.

The detection data transfer unit 10 transfers, to an external device, the position data, the velocity data, and the object recognition data in the form of the current frame. The external device is, for example, a vehicle control device 12 that controls the vehicle. The detection data transfer unit 10 also stores, in the data store 11A, the same position data transferred to the vehicle control device 12. The position data stored in the data store 11A is read by the loss extrapolator 9A when there is signal loss in the next frame.

The detection data transfer unit 10 always stores the position data for the current frame (i.e., the latest position data) in the data store 11A and transfers the position data, the velocity data, and the object recognition data to the vehicle control device 12. The position data that the detection data transfer unit 10 outputs to the vehicle control device 12 refers to the detected position data, and the velocity data that the detection data transfer unit 10 outputs to the vehicle control device 12 refers to the detected velocity data.

In the presence of signal loss in the current frame, the loss extrapolator 9A infers a direction of object movement and also infers position data and the velocity data, on the basis of the position data detected for the preceding frame and stored in the data store 11A and the camera velocity data detected for the current frame. Those position data and velocity data correspond to the current position of the object and the current velocity of the object, respectively. In the extrapolation, the loss extrapolator 9A inserts the inferred position data and the inferred velocity data into the current frame.

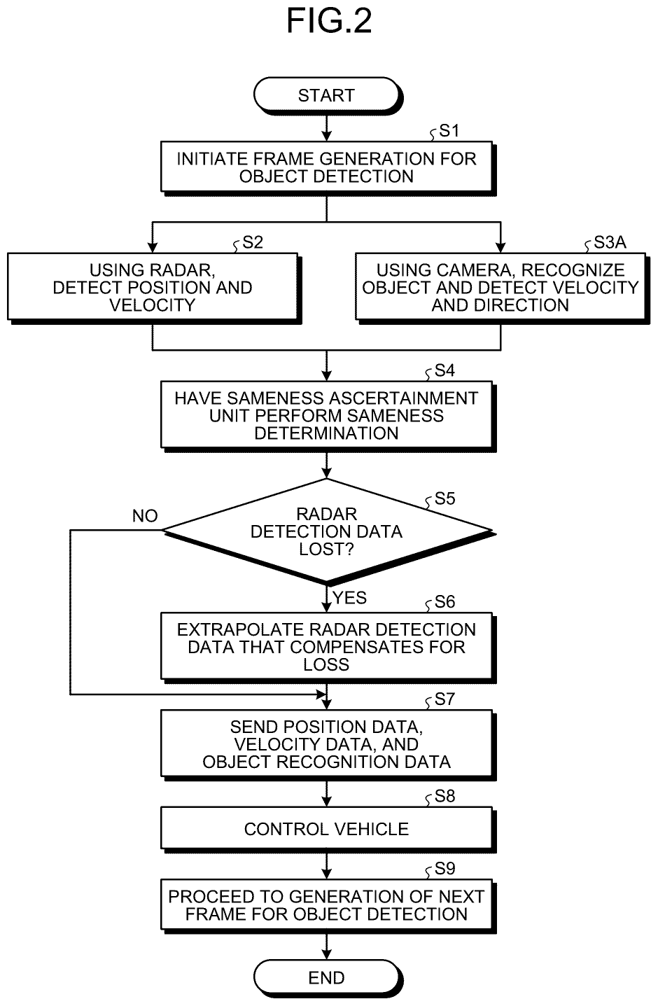

A description is provided next of an object detection procedure to be performed by the object detection apparatus 100A. FIG. 2 is a flowchart illustrating the object detection procedure to be performed by the object detection apparatus according to the first embodiment.

The object detection apparatus 100A initiates frame generation for object detection (step S1). Using the radar 1, the object detection apparatus 100A detects a position and a velocity, of an object (step S2). Specifically, the radar 1 emits electromagnetic waves toward the object, receives a reflected signal from the object, and outputs the received signal to the signal processor 3. On the basis of the signal received from the radar 1, the signal processor 3 generates radar position data indicating the object's position and radar velocity data indicating the object's velocity.

Using the camera 2, the object detection apparatus 100A recognizes the object and detects a velocity of the object and a direction in which the object is located (step S3A). Specifically, the camera 2 obtains image information on the object by capturing an image of the object and outputs the image information to the image processor 4A. On the basis of the image information obtained by the camera 2, the image processor 4A performs object recognition and also generates camera velocity data indicating the velocity of the object relative to the object detection apparatus 100A and direction data indicating the direction in which the object is located. It is to be noted that the object detection apparatus 100A performs the operation of step S2 and the operation of step S3A concurrently.

The signal processor 3 of the object detection apparatus 100A sends the radar position data and the radar velocity data to the fusion processor 5A, and the image processor 4A sends object recognition data indicating the recognition of the object, the camera velocity data, and the direction data to the fusion processor 5A.

The sameness ascertainment unit 7A of the fusion processor 5A performs object sameness determination on the basis of the radar position data, the radar velocity data, the camera velocity data, the direction data, and the object recognition data (step S4). In other words, the sameness ascertainment unit 7A determines whether the object detected by the radar 1 and the object detected by the camera 2 are the same.

Upon judging that the objects are the same, the sameness ascertainment unit 7A generates and sends to the loss determination unit 8 first correspondence data associating the radar position data and the radar velocity data that have been obtained using the radar 1, with the object recognition data and the camera velocity data that have been obtained using the camera 2.

The loss determination unit 8 determines whether radar detection data including the position and velocity data obtained using the radar 1 has been lost from the current frame (step S5). In other words, the loss determination unit 8 determines whether there is signal loss.

If the radar detection data is lost, that is to say, in the presence of the signal loss (step S5, Yes), the loss determination unit 8 sends the object recognition data and the camera velocity data to the loss extrapolator 9A.

In this case, the loss extrapolator 9A generates, by inference, position data and velocity data for the current frame on the basis of the position data stored in the data store 11A and the camera velocity data sent from the loss determination unit 8. In other words, the loss extrapolator 9A infers the current position and velocity of the object on the basis of the position data detected for the preceding frame and the camera velocity data detected for the current frame. An inference method is as follows.

Let the position data that the object detection apparatus 100A has detected for the frame (i.e., (n−1)th frame) preceding the current frame be (Xn−1, Yn−1). Let the camera velocity data detected using the camera 2 for the current frame (i.e., the nth frame) be (VXCn, VYCn). It is to be noted that X represents a horizontal coordinate relative to the object detection apparatus 100A, while Y represents a vertical coordinate relative to the object detection apparatus 100A. Therefore, Xn−1 represents a position in an X direction, while Yn−1 represents a position in a Y direction. Furthermore, VXCn represents a velocity in the X direction, while VYCn represents a velocity in the Y direction.

Using these pieces of data, the position data (Xn, Yn) to be inferred on the object for the current frame is expressed by Formulas (1) and (2) below. In Formulas (1) and (2), Tf refers to a frame update cycle time of the object detection apparatus 100A.

$$Xn = ( Xn - 1 ) + VXCn \times Tf \qquad ( 1 )$$

$$Yn = ( Yn - 1 ) + VYCn \times Tf \qquad ( 2 )$$

The velocity data (VXn, VYn) to be inferred on the object for the current frame is expressed as follows.

$$VXn = VXCn$$

$$VYn = VYCn$$

In the extrapolation, the loss extrapolator 9A inserts the generated position data and the generated velocity data into the current frame. In other words, the loss extrapolator 9A extrapolates lost radar detection data into the current frame (step S6). The loss extrapolator 9A associates the extrapolated position data, the extrapolated velocity data, and the object recognition data with each other and sends these pieces of data to the detection data transfer unit 10 (step S7). In other words, the loss extrapolator 9A sends the inferred position data (Xn, Yn), the inferred velocity data (VXn, VYn), and the object recognition data to the detection data transfer unit 10.

If, on the other hand, the radar detection data is not lost, that is to say, in the absence of signal loss (step S5, No), the loss determination unit 8 sends, to the loss extrapolator 9A, the radar position data (XRn, YRn) and the radar velocity data (VXRn, VYRn) that have been detected by the radar 1.

In this case, the loss extrapolator 9A employs the radar position data (XRn, YRn) and the radar velocity data (VXRn, VYRn) that have been detected by the radar 1 directly, as position data and velocity data. The position data (Xn, Yn) and the velocity data (VXn, VYn) that have been employed by the loss determination unit 8 are as follows.

$$Xn = XRn$$

$$Yn = YRn$$

$$VXn = VXRn$$

$$VYn = VYRn$$

The loss extrapolator 9A associates the employed position data, the employed velocity data, and the object recognition data with each other and sends these pieces of data to the detection data transfer unit 10 (step S7).

The detection data transfer unit 10 sends, to the vehicle control device 12, the position data, the velocity data, and the object recognition data that have been sent from the loss determination unit 8. The position data in the (n−1)th frame sent to the vehicle control device 12 by the detection data transfer unit 10 is defined as first detected position data. The velocity data in the (n−1)th sent frame to the vehicle control device 12 by the detection data transfer unit 10 is defined as first detected velocity data. The position data in the n th frame sent to the vehicle control device 12 by the detection data transfer unit 10 is defined as second detected position data. The velocity data in the nth frame sent to the vehicle control device 12 by the detection data transfer unit 10 is defined as second detected velocity data. The vehicle control device 12 controls the vehicle on the basis of the position data, the velocity data, and the object recognition data that have been sent from the detection data transfer unit 10 (step S8).

The object detection apparatus 100A proceeds to the generation of the next frame for object detection (step S9). As a result, the object detection apparatus 100A repeatedly performs the operations of steps S1 to S9.

As described above, even in cases where the obtained radar detection data on the object using the radar 1 is temporarily lost, the object detection apparatus 100A generates the position data and the velocity data for the current frame by using the radar detection data from the preceding frame and the data detected for the current frame using the camera 2. In other words, the object detection apparatus 100A generates the position data and the velocity data for the current frame on the basis of the position data of the preceding frame and the camera velocity data of the current frame.

In the extrapolation, the object detection apparatus 100A inserts the generated position and velocity data as the detection data into the current frame and can, as a result, remedy the loss of the radar detection data. The object detection apparatus 100A can therefore improve its performance in object detection. The object detection apparatus 100A can accurately detect an object, using the camera 2 and the image processor 4A that are of smaller size, lower manufacturing costs, and lower load.

In cases where the radar detection data is lost, the object detection apparatus 100A may generate position data and velocity data for the current frame on the basis of the position data from any previous frame before the preceding frame and the camera velocity data of the current frame. When the radar detection data is lost, the object detection apparatus 100A generates the position and velocity data for the current frame on the basis of the position data from the latest possible frame and the camera velocity data of the current frame. As described above, when the radar detection data is lost, the object detection apparatus 100A generates the position and velocity data for the current frame on the basis of the stored latest position data and the camera velocity data of the current frame that follows the frame including this latest position data.

A description is hereinafter provided of specific advantages of the use of the object detection apparatus 100A for object detection. For the object detection apparatus 100A, the position of an object is detected by only the radar 1 and the signal processor 3 while the camera 2 and the image processor 4A do not detect the position of the object. Such a configuration of the object detection apparatus 100A allows for reduced hardware and software loads of the camera 2 and the image processor 4A.

While distance measurement using a stereo camera is common in detection and output of the object position, the camera 2 of the object detection apparatus 100A is configurable as a monocular camera. The image processor 4A is configured not to detect the position and can reduce its processing capacity accordingly. For these reasons, the camera 2 and the image processor 4A of the object detection apparatus 100A need only to operate in a shorter processing time, which leads to the reduction in size and lower manufacturing costs as well.

A description is provided here of an object detection apparatus as a comparative example. For the object detection apparatus as the comparative example, a camera does not detect position data, as with the object detection apparatus 100A. The object detection apparatus as the comparative example does not include the loss determination unit 8 and the loss extrapolator 9A. For the object detection apparatus as the comparative example, position data obtained using a radar becomes positive after fusion processing, as with the object detection apparatus 100A. However, for lack of the loss determination unit 8 and the loss extrapolator 9A, the object detection apparatus as the comparative example cannot detect position data when radar detection data is lost due to a temporary operating environment.

For the object detection apparatus 100A, on the other hand, the loss determination unit 8 determines whether the radar position data and the radar velocity data that were obtained for the current frame with the radar 1 have been lost. Furthermore, the loss extrapolator 9A of the object detection apparatus 100A extrapolates the position data and the velocity data for the current frame into the current frame on the basis of the stored position data of the preceding frame and the velocity data detected for the current frame using the camera 2.

In this way, the object detection apparatus 100A can improve average accuracy of object detection even when the camera 2 is the small-sized monocular camera of lower manufacturing costs. In other words, the object detection apparatus 100A can be small-sized and achieve high-performance object detection at lower manufacturing costs as well.

As described above, the object detection apparatus 100A according to the first embodiment is capable of accurate object detection can be small-sized and detect accurately objects at lower manufacturing costs as well because the object detection apparatus 100A uses the stored position data of the preceding frame and the current camera velocity data in generating the current position and velocity data.

### Second Embodiment

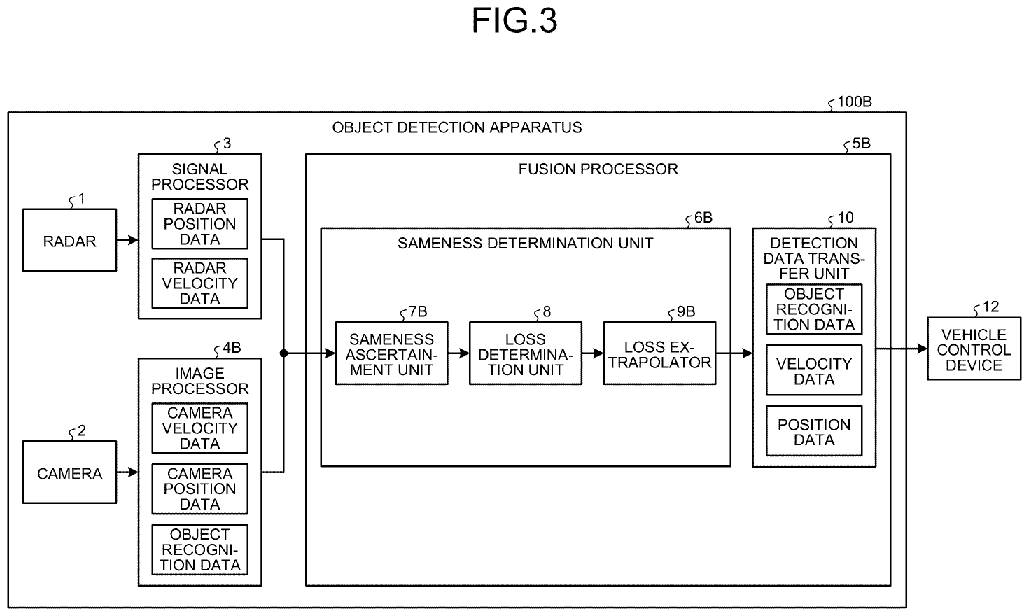

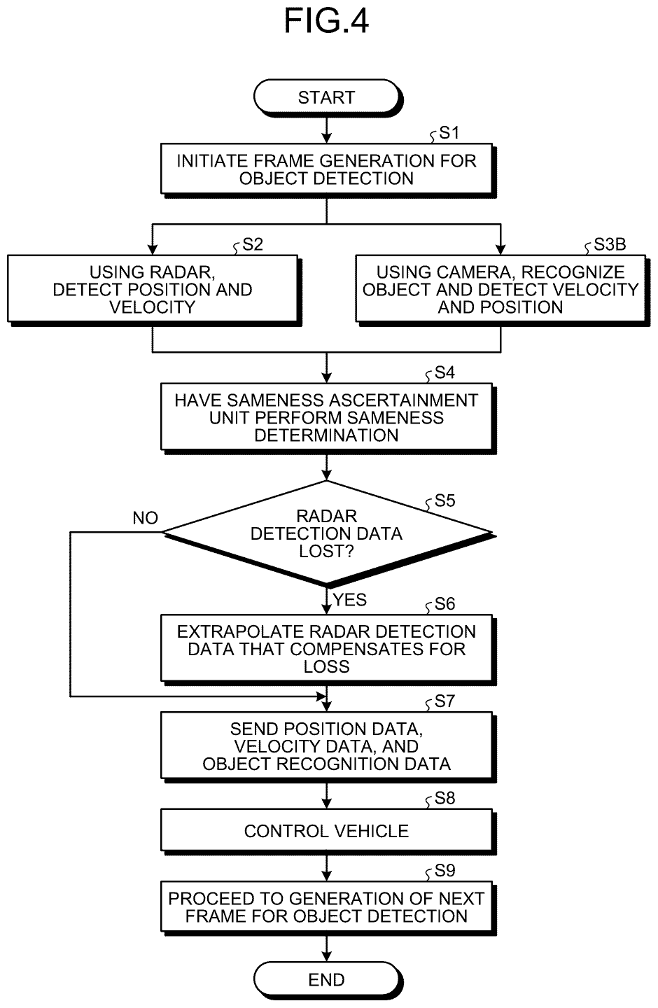

With reference to FIGS. 3 and 4, a description is provided next of a second embodiment. In the second embodiment, position data detected using the camera 2 (i.e., camera position data to be described later) is extrapolated into the current frame only when radar detection data is lost.

FIG. 3 is a diagram illustrating a configuration of an object detection apparatus according to the second embodiment. In FIG. 3, constituent elements that achieve the same functions as those of the first embodiment's object detection apparatus 100A illustrated in FIG. 1 have the same reference characters and are not redundantly described.

As with the object detection apparatus 100A, the object detection apparatus 100B is a fusion-type object detection apparatus including a combination of plural types of sensors and computes object detection data on the basis of data obtained from the plural types of sensors. When the object detection data is lost due to an operating environment, the object detection apparatus 100B uses detection data obtained for the preceding frame in inferring, among others, a position and a velocity, of an object.

The object detection apparatus 100B includes an image processor 4B instead of the image processor 4A. The object detection apparatus 100B includes a fusion processor 5B instead of the fusion processor 5A. In other words, the object detection apparatus 100B includes the radar 1, the camera 2, the signal processor 3, the image processor 4B, and the fusion processor 5B.

The fusion processor 5B includes a sameness determination unit 6B instead of the sameness determination unit 6A. The fusion processor 5B does not include the data store 11A. The sameness determination unit 6B includes a sameness ascertainment unit 7B instead of the sameness ascertainment unit 7A and a loss extrapolator 9B instead of the loss extrapolator 9A.

A description is hereinafter provided of how the image processor 4B differs from the image processor 4A and how the fusion processor 5B differs from the fusion processor 5A.

On the basis of image information obtained by the camera 2, the image processor 4B performs object recognition and also computes a velocity of the object relative to the object detection apparatus 100B and a position of the object. For example, the image processor 4B is configured with an MCU, a CPU, or the like as with the image processor 4A. As with the image processor 4A, the image processor 4B recognizes the object such as a person or an obstacle, using feature data obtained through machine learning or deep learning as a database and also computes the relative velocity and the position, of the object.

The image processor 4B sends object recognition data indicating the recognition of the object, camera velocity data, and camera position data indicating the object's position to the fusion processor 5B. As described above, the image processor 4B differs from the image processor 4A in that the image processor 4B computes the position of the object.

The sameness ascertainment unit 7B performs object sameness determination on the basis of radar position data, radar velocity data, the camera velocity data, the camera position data, and the object recognition data. Upon judging that the objects are the same, the sameness ascertainment unit 7B associates the radar position data, the radar velocity data, the object recognition data, the camera velocity data, and the camera position data with each other. The sameness ascertainment unit 7B sends these associated data (hereinafter referred to as second correspondence data) to the loss determination unit 8 connected downstream.

As with the loss determination unit 8 according to the first embodiment, the loss determination unit 8 according to the second embodiment determines whether there is loss of a signal for the radar position data and the radar velocity data.

If there is no signal loss, the loss determination unit 8 sends the radar position data, the radar velocity data, and the object recognition data to the loss extrapolator 9B. If there is the signal loss, the loss determination unit 8 sends the object recognition data, the camera velocity data, and the camera position data to the loss extrapolator 9B.

The loss extrapolator 9B performs data extrapolation only when the loss determination unit 8 has detected the data loss. In the absence of signal loss, the loss extrapolator 9B sends, to the detection data transfer unit 10, the radar position data, the radar velocity data, and the object recognition data that have been sent from the loss determination unit 8. The radar position data, the radar velocity data, and the object recognition data are defined as position data, velocity data, and object recognition data, respectively, all of which are detected by the object detection apparatus 100B.

In the presence of signal loss, the loss extrapolator 9B extrapolates position data and velocity data that are to be generated for the current frame into the current frame and transfers the position and velocity data to the detection data transfer unit 10. Specifically, in the presence of signal loss, the loss extrapolator 9B transfers, to the detection data transfer unit 10, the camera position data, the camera velocity data, and the object recognition data. The camera position data, the camera velocity data, and the object recognition data are defined as the position data, the velocity data, and the object recognition data, respectively, all of which are detected by the object detection apparatus 100B.

A description is provided next of an object detection procedure to be performed by the object detection apparatus 100B. FIG. 4 is a flowchart illustrating the object detection procedure to be performed by the object detection apparatus according to the second embodiment. Descriptions of operations in FIG. 4 that are identical to those described in FIG. 2 are omitted.

The object detection apparatus 100B performs the operations of steps S1 and S2. The object detection apparatus 100B according to the second embodiment performs step S3B instead of step S3A. In other words, using the camera 2, the object detection apparatus 100B recognizes the object and detects a velocity and a position of the object (step S3B). Specifically, the camera 2 obtains object image information by capturing an image of the object and outputs the image information to the image processor 4B.

On the basis of the image information obtained by the camera 2, the image processor 4B performs object recognition and also generates camera velocity data indicating the velocity of the object relative to the object detection apparatus 100B and camera position data indicating the position of the object relative to the object detection apparatus 100B. The image processor 4B sends object recognition data indicating the recognition of the object, the camera velocity data, and the camera position data to the fusion processor 5B. It is to be noted that the object detection apparatus 100B performs the operation of step S2 and the operation of step S3B concurrently.

The sameness ascertainment unit 7B of the fusion processor 5B performs object sameness determination based on the radar position data, the radar velocity data, the camera velocity data, the camera position data, and the object recognition data (step S4).

Upon judging that the objects are the same, the sameness ascertainment unit 7B generates and sends to the loss determination unit 8 second correspondence data associating the radar position data and the radar velocity data with the object recognition data, the camera velocity data, and the camera position data that have been obtained using the camera 2.

The loss determination unit 8 of the object detection apparatus 100B determines whether radar detection data including the radar position data and the radar velocity data has been lost (step S5). If the radar detection data is lost, that is to say, in the presence of signal loss (step S5, Yes), the loss determination unit 8 then sends the object recognition data, the camera position data, and the camera velocity data to the loss extrapolator 9B.

If the radar detection data is lost, the loss extrapolator 9B extrapolates the camera position data and the camera velocity data into the current frame. In other words, if the radar detection data is lost, the loss extrapolator 9B employs the camera position data as position data for the current frame and employs the camera velocity data as velocity data for the current frame. In this manner, the loss extrapolator 9B extrapolates lost radar detection data into the current frame (step S6).

Thereafter, the object detection apparatus 100B performs the operation of step S7 and subsequent operations that are identical to those of the object detection apparatus 100A. It is to be noted that the loss extrapolator 9B performs the same operation that the loss extrapolator 9A performs when the radar detection data is not lost.

A description is hereinafter provided of specific advantages of the use of the object detection apparatus 100B for object detection. The object detection apparatus 100B computes the radar position data through the detection by the radar 1 and the camera position data through the detection by the camera 2.

Camera position data and camera velocity data, which detected using small-sized monocular camera 2 of lower manufacturing costs, are generally less accurate than the radar position data and the radar velocity data detected using the radar 1. For this reason, the object detection apparatus 100B uses the data detected by the camera 2 only when the data detected by the radar 1 is lost. In other words, the object detection apparatus 100B extrapolates the camera position data and the camera velocity data into the current frame only if the radar position data and the radar velocity data are lost. In this way, the object detection apparatus 100B can improve average accuracy of object detection even when the camera 2 is the small-sized monocular camera of lower manufacturing costs.

As described above, even in cases where the radar detection data is temporarily lost, the object detection apparatus 100B according to the second embodiment infers the radar detection data on the basis of the detection data that the object detection apparatus 100B has detected for the preceding frame and the data detected for the current frame using the camera 2. As a result, the object detection apparatus 100B can remedy the loss of the radar detection data and improve the average object detection accuracy. The object detection apparatus 100B can therefore accurately detect an object, using the camera 2 and the image processor 4B that are of smaller size, lower manufacturing costs, and lower load.

A description is provided here of a hardware configuration of both the object detection apparatuses 100A and 100B. The object detection apparatuses 100A and 100B are both implemented with processing circuitry. The processing circuitry may include a memory and a processor that executes programs stored in the memory or may be dedicated hardware such as dedicated circuitry. The processing circuitry is also referred to as control circuitry.

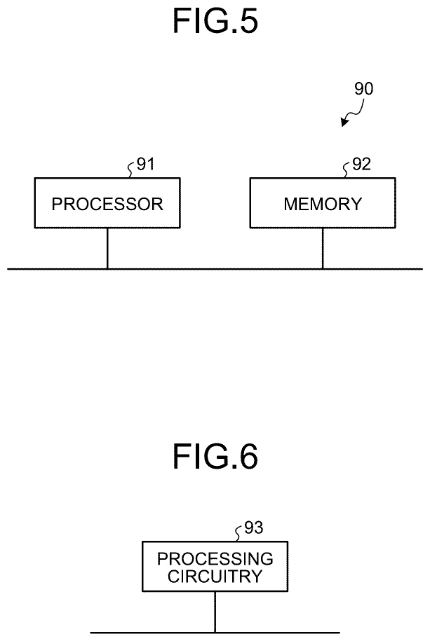

FIG. 5 is a diagram illustrating a configuration example of processing circuitry of each of the object detection apparatuses according to the first and second embodiments when the processing circuitry is realized by a processor and a memory. Since the object detection apparatuses 100A and 100B have the same hardware configuration, a description is hereinafter provided of the hardware configuration of the object detection apparatus 100A.

The processing circuitry 90 illustrated in FIG. 5 is control circuitry and includes the processor 91 and the memory 92. When the processing circuitry 90 includes the processor 91 and the memory 92, the functions of the processing circuitry 90 are implemented with software, firmware, or a combination of software and firmware. The software or the firmware is described as programs and is stored in the memory 92. In the processing circuitry 90, the processor 91 reads and executes the programs stored in the memory 92 to implement the functions. This means that the memory 92 is included in the processing circuitry 90 to store the programs with which the operations of the object detection apparatus 100A are eventually executed. These programs can be said to be programs that cause the functions implemented by the processing circuitry 90 to be performed by the object detection apparatus 100A. These programs may be stored in a storage medium and provided, or may be provided by another means such as a communication medium. The above programs can also be said to cause the object detection apparatus 100A to perform the object detection process.

Examples of the processor 91 include a central processing unit (CPU) that is also referred to as a processing unit, an arithmetic unit, a microprocessor, a microcomputer, or a digital signal processor (DSP) and a system large-scale integration (LSI).

Examples that each correspond to the memory 92 include nonvolatile or volatile semiconductor memories, such as a random-access memory (RAM), a read-only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD), among others.

FIG. 6 is a diagram illustrating an example of the processing circuitry of each of the object detection apparatuses according to the first and second embodiments when the processing circuitry is configured as dedicated hardware. Examples that each correspond to the processing circuitry 93 illustrated in FIG. 6 include a single circuit, a composite circuit, a programmed processor, a parallel programmed processor, an application-specific integrated circuit (ASIC), a field-programmable gate array (FPGA), and combinations of these. The processing circuitry 93 may be realized partly by dedicated hardware and partly by software or firmware. By including the dedicated hardware, the software, the firmware or a combination of these, the processing circuitry 93 is capable of implementing the above functions. As mentioned earlier, the signal processor 3 and the image processor 4A may be configured with the separate CPUs.

The above configurations illustrated in the embodiments are illustrative, can be combined with other techniques that are publicly known, and can be partly omitted or changed without departing from the gist. The embodiments can be combined together.

### REFERENCE SIGNS LIST

1 radar; 2 camera; 3 signal processor; 4A, 4B image processor; 5A, 5B fusion processor; 6A, 6B sameness determination unit; 7A, 7B sameness ascertainment unit; 8 loss determination unit; 9A, 9B loss extrapolator; 10 detection data transfer unit; 11A data store; 12 vehicle control device; 90, 93 processing circuitry; 91 processor; 92 memory; 100A, 100B object detection apparatus.

1. An object detection apparatus comprising:
a radar to emit an electromagnetic wave toward an object and receive a reflected signal from the object;
a signal processor to compute radar position data and radar velocity data on a basis of the reflected signal, the radar position data indicating a position of the object, the radar velocity data indicating a velocity of the object;
a camera to obtain object image information by capturing an image of the object;
an image processor to compute camera velocity data on a basis of the object image information, the camera velocity data indicating a velocity of the object; and
a fusion processor to output, to an external device, the radar position data and the radar velocity data of a first frame as first detected position data and first detected velocity data, the first detected position data indicating the position of the object for the first frame, the first detected velocity data indicating the velocity of the object for the first frame, wherein
the fusion processor includes a data store to store the first detected position data, and
when the radar position data and the radar velocity data of a second frame following the first frame are lost, the fusion processor generates second detected position data indicating the position of the object for the second frame and second detected velocity data indicating the velocity of the object for the second frame on a basis of the first detected position data and the camera velocity data obtained for the second frame and outputs the second detected position data and the second detected velocity data to the external device.

2. The object detection apparatus according to claim 1, wherein
the image processor computes direction data on the basis of the object image information, the direction data indicating a direction where the object is located,
the fusion processor includes a sameness ascertainment circuitry to perform object sameness determination of whether the radar and the camera have detected the same object, and
the sameness ascertainment circuitry performs the object sameness determination on the basis of the radar position data, the radar velocity data, the camera velocity data, and the direction data.

3. An object detection apparatus comprising:
a radar to emit an electromagnetic wave toward an object and receive a reflected signal from the object;
a signal processor to compute radar position data and radar velocity data on a basis of the reflected signal, the radar position data indicating a position of the object, the radar velocity data indicating a velocity of the object;
a camera to obtain object image information by capturing an image of the object;
an image processor to compute camera velocity data and camera position data on a basis of the object image information, the camera velocity data indicating a velocity of the object, the camera position data indicating a position of the object; and
a fusion processor to output, to an external device, the radar position data and the radar velocity data of a first frame as first detected position data and first detected velocity data, the first detected position data indicating the position of the object for the first frame, the first detected velocity data indicating the velocity of the object for the first frame, wherein
when the radar position data and the radar velocity data of a second frame following the first frame are lost, the fusion processor outputs, to the external device, the camera velocity data and the camera position data of the second frame as second detected position data and second detected velocity data, the second detected position data indicating the position of the object for the second frame, the second detected velocity data indicating the velocity of the object for the second frame.

4. The object detection apparatus according to claim 3, wherein
the fusion processor includes a sameness ascertainment circuitry to perform object sameness determination of whether the radar and the camera have detected the same object, and
the sameness ascertainment circuitry performs the object sameness determination on the basis of the radar position data, the radar velocity data, the camera velocity data, and the camera position data.

5. An object detection method comprising:
computing radar position data and radar velocity data on a basis of a reflected signal from an object, the radar position data indicating a position of the object, the radar velocity data indicating a velocity of the object;
computing camera velocity data on a basis of the object image information, the camera velocity data indicating a velocity of the object; and
outputting, to an external device, the radar position data and the radar velocity data of a first frame as first detected position data and first detected velocity data, the first detected position data indicating the position of the object for the first frame, the first detected velocity data indicating the velocity of the object for the first frame, wherein
the method comprises
storing the first detected position data in outputting the first detected position data and the first detected velocity data to the external device, and
when the radar position data and the radar velocity data of a second frame following the first frame are lost, generating, on a basis of the first detected position data and the camera velocity data obtained for the second frame, second detected position data indicating the position of the object for the second frame and second detected velocity data indicating the velocity of the object for the second frame, and outputting the second detected position data and the second detected velocity data to the external device.
